(19) United States
(12) Patent Application Publication
(10) Pub. No.: US 2016/0246813 A1
(43) Pub. Date: Aug. 25, 2016

(54) SYSTEM AND METHOD FOR MACHINE INFORMATION LIFE CYCLE

(71) Applicant: International Business Machines Corporation, Armonk, NY (US)

(72) Inventors: Sameh A. Nasef, Katamya (EG); Ossama Shokry, Giza (EG)

(21) Appl. No.: 14/630,713

(22) Filed: Feb. 25, 2015

(51) Int. Cl. G06F 17/30

(52) U.S. Cl. CPC G06F 17/30165; G06F 17/3007

(57) ABSTRACT

In an approach for maintaining machine life cycle records, wherein the information about the machine is received. A processor creates a profile of the machine, wherein the profile includes the information about the machine. A processor receives a request to access the profile from a first user. A processor determines that the first user is authorized to access the profile. A processor permits the first user access to the machine profile.

### BACKGROUND

The present invention relates generally to the field of record keeping for machine life cycle, and more particularly to create a platform for managing machine information throughout the machine's life cycle.

Record management is the process of controlling and governing records throughout the record's life-cycle, which includes from the time such records, are conceived through to their eventual disposal. Record management includes identifying, classifying, prioritizing, storing, securing, archiving, preserving, retrieving, tracking, and eventually destroying records. Record management is associated with the discipline known as Governance, Risk, and Compliance, and is concerned with the evidence of an organization's activities, as well as the reduction of risk and increase in knowledge associated with record.

A record is something that represents proof of existence and that can be used to recreate or prove state of existence, regardless of medium or characteristic. A record is either created or received by an organization in pursuance of compliance, or in the transaction of business. When a machine is created, is in an operating capacity, is down for maintenance, experiencing issues with run cycles, sub-systems, or components, and is eventually terminated; these actions or events are records of the machine's history. Maintaining these machine records helps one to understand the machine's effectiveness, efficiency, and quality. These machine records assist in improvements in the machine's operation and productivity.

### SUMMARY

Aspects of an embodiment of the present invention include an approach for maintaining machine life cycle records. A processor receives information about a machine. A processor creates a profile of the machine, wherein the profile includes the information about the machine. A processor receives a request to access the profile from a first user. A processor determines that the first user is authorized to access the profile. A processor permits the first user access to the machine profile.

### BRIEF DESCRIPTION OF THE SEVERAL VIEWS OF THE DRAWINGS

FIG. 1 depicts a block diagram of a computing environment, in accordance with one embodiment of the present invention.

FIG. 2 is a flowchart depicting operational steps for maintaining the machine profile information, within the computing environment of FIG. 1, in accordance with one embodiment of the present invention.

FIG. 3 is a flowchart depicting operational steps for determining whether a user has access to a machine profile, within the computing environment of FIG. 1, in accordance with one embodiment of the present invention.

FIG. 4 is a block diagram of internal and external components of the server and the authorized user computing device of FIG. 1, in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may generally be referred to herein as a “circuit,” “module”, or “system.” Furthermore, aspects of the present invention may take the form of a computer program product embodied in one or more computer readable medium(s) having computer readable program code/instructions embodied thereon.

Embodiments of the present invention recognize that there are many different methods and standards for record keeping for machine life cycle. Embodiments of the present invention disclose an approach to gather and store information related to machine life cycles, and to grant access to this information to approved applications and/or users

Embodiments of the present invention disclose a method, computer program product, and computer system, to provide a process for record keeping for machine life cycle.

The present invention will now be described in detail with reference to the Figures.

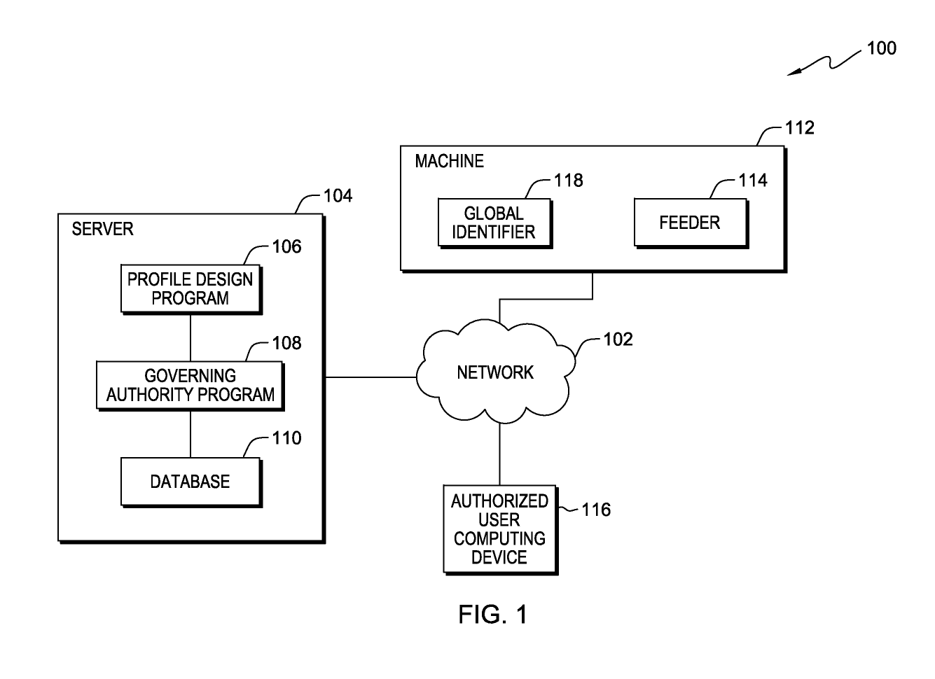

FIG. 1 depicts a block diagram of computing environment 100 in accordance with one embodiment of the present invention. FIG. 1 provides an illustration of one embodiment and does not imply any limitations regarding computing environment 100 in which different embodiments may be implemented. In the depicted embodiment, computing environment 100 includes, but is not limited to, server 104, machine 112, and authorized user computing device 116. Computing environment 100 may include additional computing devices, servers, computers, components, or other devices not shown.

Network 102 may be a local area network (LAN), a wide area network (WAN) such as the Internet, any combination thereof, or any combination of connections and protocols that support communications between server 104, machine 112, and authorized user computing device 116 in accordance with embodiments of the invention. Network 102 may include wired, wireless, or fiber optic connections.

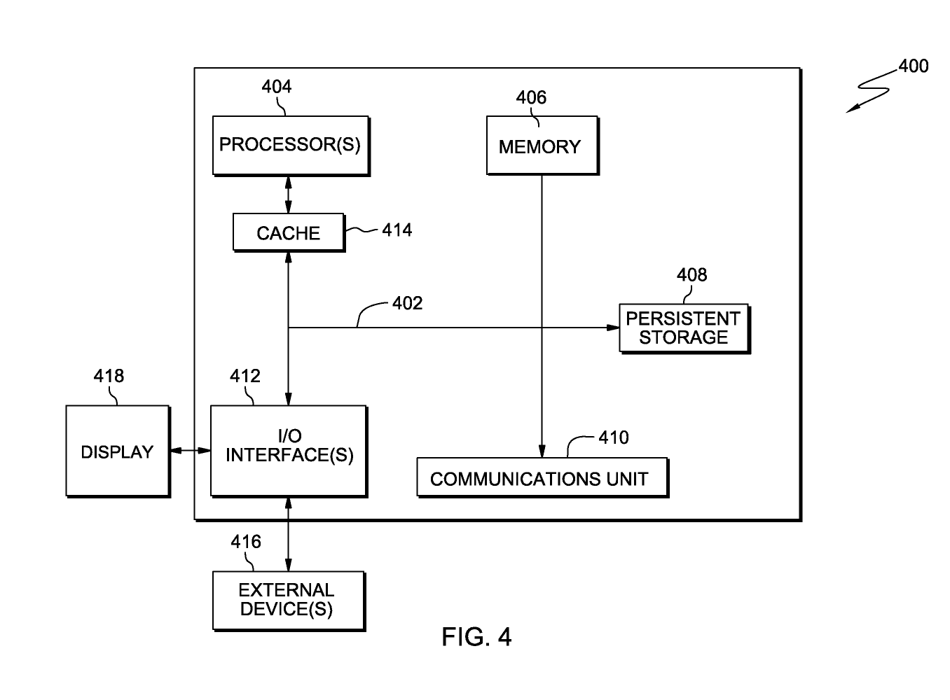

Server 104 may be a management server, a web server, or any other electronic device or computing system capable of processing program instructions and receiving and sending data. In some embodiments, server 104 may be a laptop computer, tablet computer, netbook computer, personal computer (PC), a desktop computer, or any programmable electronic device capable of communicating with machine 112, computing device 114, and authorized user computing device 116 via network 102. In other embodiments, server 104 may represent a server computing system utilizing multiple computers as a server system, such as in a cloud computing environment. In another embodiment, server 104 represents a computing system utilizing clustered computers and components to act as a single pool of seamless resources. In the depicted embodiment, server 104 includes profile design program 106, governing authority program 108, and database 110. Server 104 may include components, as depicted and described in further detail with respect to FIG. 4.

Machine 112 is an apparatus that performs a particular task. Machine 112 can be complete machine or a sub-system of a larger machine 112. In the depicted embodiment, machine 112 is connected to network 102. In other embodiments, machine 112 does not have to be directly connected to network 102, so long as profile design program 106 is connected to machine 112 so profile design program can access machine 112 information. In some embodiments, machine 112 is a single machine with an individual serial number or identification number. In other embodiments, machine 112 may be a series of machines which are identical. In the depicted embodiment, machine 112 includes global identifier 118 and feeder 114. In other embodiments, machine 112 does not include global identifier 118 but has access to global identifier 118 via network 102.

Profile design program 106 is used to define the structure of machine 112. In one embodiment, profile design program 106 creates an initial profile for machine 112 and records initial machine information in database 110. Machine information can include, but is not limited to, information related to operation cost, purchase cost, run time, parts list, date of creation, energy consumption, location, operators, owner, model number, serial number, engine type, parts used in the build, build time, manufacturing date, amount of energy used in manufacturing process, cost of machine build, cost of machine components, cost of operation, life cycle of machine 112, errors registered by machine 112, notification of decommission, decommission date, and other information related to the construction and operation of machine 112. In one embodiment, machine information is stored in database 110. In other embodiments, machine information is stored in another location that, through network 102, profile design program 106 can access machine information. In one embodiment, machine information is input into profile design program 106 manually. In other embodiments, machine 112 is connected to network 102, communicates with profile design program 106, and periodically updates machine profile throughout the life cycle of machine 112. In other embodiments, machine 112 uploads machine information to database 110 so that profile design program 106 has access to the machine information. Machine 112 may upload machine information periodically, or when the information is requested.

Global identifier 118 is an indicator which distinguishes machine 112 from other machines. Global identifier 118 can be, but is not limited to, a serial number, bar code, machine name, machine location, radio-frequency identification (RFID) tag, or other identifier used to distinguish one machine 112 from another machine 112. In one embodiment, global identifier 118 value is coupled to machine 112 when global identifier 118 is first created. In other embodiments, global identifier 118 value is coupled with machine 112 at a later stage in its life cycle. In the depicted embodiment, global identifier 118 is located on or within machine 112. In other embodiments, global identifier 118 may stand alone as a standalone component located on server 104, authorized user computing device 116, or any other computing device, provided that global identifier 118 is accessible to machine 112, feeder 114, profile design program 106, or governing authority program 108.

Feeder 114 is a component that communicates changes or modifications that happen to machine 112. Feeder 114 tracks changes that happen to machine 112. The changes can be maintenance, upgrades, replacement of broken components, or other changes that would occur through a machines life cycle. Feeder 114 communicates these changes with global identifier 118, profile design program 106, or governing authority program 108. In the depicted embodiment, feeder 114 is located on machine 112. In other embodiments, feeder 114 may stand alone as a program located on server 104, authorized user computing device 116, or any other computing device, provided that feeder 114 has access to machine 112, governing identifier 118, profile design program 106, or governing authority program 108.

Authorized user computing device 116 may be a desktop computer, laptop computer, tablet computer, netbook computer, personal computer (PC), mobile device, or any programmable electronic device capable of communicating via network 102. In other embodiments, authorized user computing device 116 may be any electronic device or computing system capable of sending and receiving data and communicating with server 104 and machine 112 via network 102. Authorized user computing device 116 is capable of accessing database 110 to gain access machine 112 profiles and machine 112 records. The user of authorized user computing device 116 can be, for example, the owner of machine 112, the manufacturer of machine 112, a sub-system used in machine 112, the operator of machine 112, a governing authority or an authorized entity. In some embodiments, authorized users are selected and determined by governing authority program 108. In the depicted embodiment, authorized user computing device 106 can access server 104 and machine 112 via network 102. In other embodiments, authorized user computing device 116 communicates with other servers, and devices via network 102.

Governing authority program 108 is responsible for maintaining machine information of machine 112, publishing and maintaining system standards, and governing control of authorized user computing device 116 to machine profiles and machine records. System standards are used to determine what information is recorded by profile design program 106 from machine 112. The information can be different for each machine 112 or the same for each machine 112. In one embodiment, governing authority program 108 maintains the machine information of machine 112 throughout the entire life cycle of machine 112. In one embodiment, governing authority program 108 governs and controls access for users, permitting authorized user computing device 116 to access and/or modify machine information while blocking users who are not authorized to access and/or modify machine information. In one embodiment, governing authority program 108 stores machine information, and a list of authorized user on database 110. In other embodiments, governing authority program 108 stores machine information and list of authorized user on another database or storage device, so long as governing authority program 108 has access to the database or storage device via network 102.

Database 110 may be a repository that may be written to and/or read by profile design program 106, governing authority program 108, authorized user computing device 116, or machine 112 via network 102. Information gathered by profile design program 106, governing authority program 108, authorized user computing device 116, or machine 112 may be stored to database 110. In one embodiment, database 110 is a database management system (DBMS) used to allow the definition, creation, querying, update, and administration of a database(s). In one embodiment, machine information is stored on database 110. In the depicted embodiment, database 110 is stored on server 104 and connected to network 402. In other embodiments, database 110 may resides on a server, or another computing device, provided that database 110 is accessible to profile design program 106, governing authority program 108, authorized user computing device 116, or machine 112.

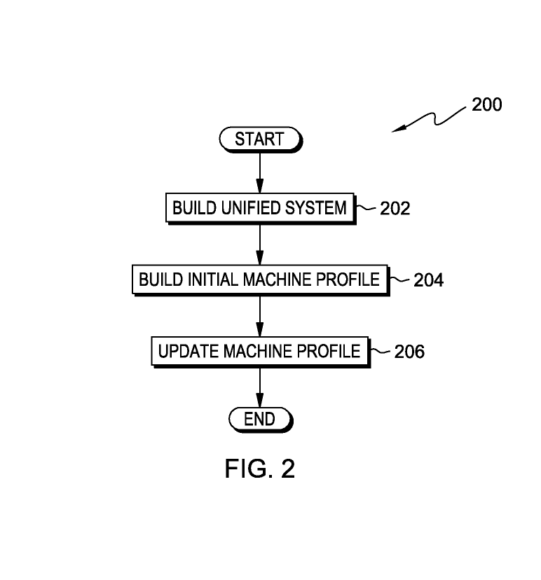

FIG. 2 depicts a flowchart 200 of the steps taken by profile design program 106 for building and updating a machine profile within computing environment 100 of FIG. 1, in accordance with an embodiment of the present invention. Flowchart 200 depicts the creation and maintenance of machine information throughout machine 112's life cycle and addresses the issue of allowing only authorized users can access to machine information.

In step 202, profile design program 106 builds the unified system for information about machine 112. The unified system parameters can be determined by a user or computer program that is authorized to determine the parameters. The unified system determines which information related to machine 112 is stored, when the information is stored, how the information is stored, who is submitting the information, who has access to the information, and how updates to machine 112 are handled. In one embodiment, governing authority program 108 builds the list of users whom have access to create and/or modify the machine profile in profile design program 106. In one embodiment, governing authority program 108 builds the list of entries users are allowed to edit/modify from machine 112, the list of entries includes but is not limited to: machine cost, run time, parts list, date of creation, energy consumption, location, operators, owner, model number, serial number, engine type, parts used in the build, build time, manufacturing date, amount of energy used in manufacturing process, cost of machine build, cost of machine components, cost of operation, life cycle of machine 112, errors registered by machine 112, notification of decommission, decommission date, and other information related to the construction and operation of machine 112. In one embodiment, governing authority program 108 compiles a list of authorized users, and the actions each authorized user can perform on the machine profile of the machine 112. In another embodiment, governing authority program 108 complies a list of authorized user's computing devices, and the actions each authorized user computing device 116 can perform on the machine profile of machine 112. These actions include, but are not limited to, writing, modifying, viewing, and any other action can be performed to machine information. In one embodiment, the unified system is built using a social network pattern to link authorized user computing device 116 to machine 112 via network 102 to gain access to the information. In other embodiments, governing authority program 108 periodically updates the list of authorized user computing device 116 to keep the information up-to-date and current with those who have access to machine information. In other embodiments, governing authority program 108 creates an original list of authorized users and does not change the list for the life of machine 112.

In step 204, profile design program 106 builds the initial machine profile for machine 112. Operational information can include, but is not limited to, machine cost, run time, parts list, date of creation, energy consumption, location, operators, owner, model number, serial number, engine type, parts used in the build, build time, manufacturing date, amount of energy used in manufacturing process, cost of machine build, cost of machine components, cost of operation, life cycle of machine 112, errors registered by machine 112, notification of decommission, decommission date, and other information related to the construction and operation of machine 112. Feeder 104 gathers the information and compiles machine information for authorized user computing device 116 to access. In one embodiment, feeder 104 periodically updates machine information. In other embodiments, feeder 104 updates machine information at predetermined times and events. In some embodiments, a manufacturer uses profile design program 106 to define the structure of the information for machine 112, the feeder communicates with governing authority program 108.

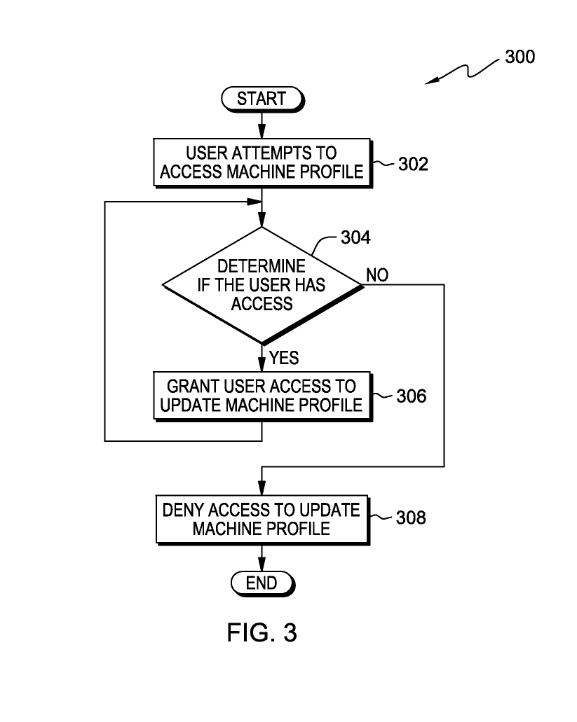

In step 206, profile design program updates machine information when governing authority program 108 grants a user privilege to modify the machine profile (see FIG. 3, step 306) or machine 112 is modified. In one embodiment, feeder 104 updates machine information when governing authority program 108 grants a user privilege to modify the machine profile or machine 112 is modified. In one embodiment, feeder 104 updates the machine profile periodically as machine 112 is operational, after components of machine 112 are replaced, components of machine 112 are updated, or when feeder 114 gathers information that profile design program 104 is required to gather and store. In other embodiments, feeder 114 relays information at a structured time set by profile design program 104. In other embodiments, feeder 114 gathers information and a third party manually transfers machine information from feeder 114 to governing authority program 108. In other embodiments, profile design program 104 requires authorization before the information for the machine profile is updated by a user.

FIG. 3 depicts flowchart 300 of the steps taken by governing authority program 108 for determining if a user has access to the machine profile within computing environment 100 of FIG. 1, in accordance with an embodiment of the present invention. Flowchart 300 depicts the determination, access, or denial of a user to machine profile.

In step 302, governing authority program 108 registers that a user has attempted to access the machine profile. The user may be accessing the machine profile to view, modify, or make other alterations to the machine profile. When the user attempts to access the machine profile, governing authority program 108 is informed of the user's attempt to access the machine profile.

In decision 304, governing authority program 108 determines if the user is an authorized to access the machine profile for machine 112. Governing authority program 109 may determine whether the user is authorized to access the machine profile for machine 112 by comparing the user attempting to access the machine profile to a list of users. Database 110 may be populated with a list of users, and the actions the users are permitted to make to the machine profile of machine 112. In other embodiments, profile design program 106 populates the machine profile of machine 112 with a list of users and the actions the users are permitted to make with the machine profile of machine 112. If governing authority program 108 determines that the user has the necessary clearance to update the machine profile (decision 304, yes branch), governing authority program 108 grants the user access to the machine profile (see step 306). If governing authority program 108 determines that the user does not have the necessary clearance (decision 304, no branch), governing authority program 108 denies the user access to the machine profile (see step 308).

In step 306, governing authority 108 grants access to a user to update the machine profile. Governing authority 108 determines what actions the user is granted to make regarding the machine profile. In one embodiment, the user is attempting to access the machine profile via authorized user computing device 116 and governing authority 108 grants the user access to perform the necessary actions to the machine profile. Each authorized user computing device 116 has a set of actions they are allowed to perform on machine 112. In one embodiment, authorized user computing device 116 could be an owner or operator of machine 112 and the associated machine profile can be linked to owner's information. The machine profile can be updated with changes to owner's information such as home address, way of payment, or transfer ownership of machine 112. In another embodiment, authorized user computing device 116 could be a machinist, and the machinist could feed different usage information of machine 112 into the machine profile. In another embodiment, authorized user computing device 116 could be a maintenance center, and the maintenance center user could feed the machine profile with status reports, activities of machine 112, maintenance procedures are applied to machine 112, machine parts that have been replaced or need to be replaced, or other information the maintenance user has access to. In some embodiments, after authorized user computing device 116 is granted access to update the machine profile, authorized user computing device 116 always has access to the machine profile. In other embodiments, authorized user computing device 116 needs to be reauthorized before access is granted to allow a user to update the machine profile each time the authorized user attempts to gain access to the machine profile. In other embodiments, the user does not have to be at authorized user computing device 116, and governing authority 108 may determine that the user is authorized to gain access to the machine profile. For example, a user may be able to login to the machine profile at another computing device by supplying a password or other authentication requirement.

In step 308 governing authority 108 denies an unauthorized user access to perform the requested operation to machine information. In one embodiment, governing authority program 108 reports the unauthorized user to another application to inform the necessary authorities of the unauthorized attempted access. In other embodiments, governing authority program 108 does not allow the unauthorized user access to machine information.

FIG. 4 depicts a block diagram 400 of components of server 104 and authorized user computing device 116, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server 104 and authorized user computing device 116 each include, respectively, communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In one embodiment, memory 406 includes random access memory (RAM). In general, memory 406 can include any suitable volatile or non-volatile computer readable storage media. Cache 414 is a fast memory that enhances the performance of computer processor(s) 404 by holding recently accessed data, and data near accessed data, from memory 406.

Profile design program 106, governing authority program 108, and database 110 may each be stored in persistent storage 408 of server 104 and in memory 406 of server 104 for execution and/or access by one or more of the respective computer processors 404 of server 104 via cache 414 of server 104. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in the examples, provides for communications with other data processing systems or devices, including server 104. In the examples, communications unit 410 includes one or more network interface cards. Communications unit 410 may provide communications through the use of either or both physical and wireless communications links. Profile design program 106, governing authority program 108, and database 110 may each be downloaded to persistent storage 408 of server 104 through communications unit 410 of server 104.

I/O interface(s) 412 allows for input and output of data with other devices that may be connected to server 104. For example, I/O interface 412 may provide a connection to external devices 416 such as a keyboard, keypad, camera, a touch screen, and/or some other suitable input device. External devices 416 can also include portable computer-readable storage media such as, for example, thumb drives, portable optical or magnetic disks, and memory cards. Software and data used to practice embodiments of the present invention, e.g., profile design program 106, governing authority program 108, and database 110, can be stored on such portable computer-readable storage media and can be loaded onto persistent storage 408 of server 104 via I/O interface(s) 412 of server 104.

Display 418 provides a mechanism to display data to a user and may be, for example, a computer monitor.

The programs described herein are identified based upon the applications for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for maintaining machine life cycle records, the method comprising:
receiving, by one or more processors, information about a machine;
creating, by one or more processors, a profile of the machine, wherein the profile includes the information about the machine;
receiving, by one or more processors, a request to access the profile from a first user;
determining, by one or more processors, that the first user is authorized to access the profile; and
permitting, by one or more processors, the first user access to the profile of the machine.

2. The method of claim 1, further comprising:
receiving, by one or more processors, an indication that at least one aspect of the machine has been modified from an original design of the machine; and
updating, by one or more processors, the profile of the machine to include the at least one aspect of the machine that has been modified.

3. The method of claim 1, wherein the information about the machine includes factors selected from a group consisting of model number, serial number, manufacturing date, energy consumption, run cycle, errors, and modifications.

4. The method of claim 1, wherein determining that the first user is authorized to access the profile comprises:
accessing, by one or more processors, a list of users authorized to access the profile of the; and
identifying that the first user corresponds to a user from the list of users authorized to access the profile of the machine.

5. The method of claim 1, further comprising:
receiving, by one or more processors, a request to access the profile from a second user;
determining, by one or more processors, that the second user is unauthorized to access the profile; and
denying, by one or more processors, the second user access to the profile of the machine.

6. The method of claim 5, further comprising:
reporting, by one or more processors, the unauthorized attempt by the second user to access the profile of the machine.

7. The method of claim 1, further comprising:
receiving, by one or more processors, a notification that the machine is to be decommissioned; and
recording, by one or more processors, information about decommissioning of the machine.

8. A computer program product for maintaining machine life cycle records, the computer program product comprising:
one or more computer readable storage media and program instructions stored on the one or more computer readable storage media, the program instructions comprising:
program instructions to receive information about a machine;
program instructions to create a profile of the machine, wherein the profile includes the information about the machine;
program instructions to receive a request to access the profile from a first user;
program instructions to determine that the first user is authorized to access the profile; and
program instructions to permit the first user access to the profile of the machine.

9. The computer program product of claim 8, further comprising:
program instructions, stored on the one or more computer readable storage media, to receive an indication that at least one aspect of the machine has been modified from an original design of the machine; and
program instructions, stored on the one or more computer readable storage media, to update the profile of the machine to include the at least one aspect of the machine that has been modified.

10. The computer program product of claim 8, wherein the information about the machine includes factors selected from a group consisting of model number, serial number, manufacturing date, energy consumption, run cycle, errors, and modifications.

11. The computer program product of claim 8, wherein program instructions to determine that the first user is authorized to access the profile comprise:
program instructions to access a list of users authorized to access the profile of the machine; and
program instructions to identify that the first user corresponds to a user from the list of users authorized to access the profile of the machine.

12. The computer program product of claim 8, further comprising:
program instructions, stored on the one or more computer readable storage media, to receive a request to access the profile from a second user;
program instructions, stored on the one or more computer readable storage media, to determine that the second user is unauthorized to access the profile; and
program instructions, stored on the one or more computer readable storage media, to deny the second user access to the profile of the machine.

13. The computer program product of claim 12, further comprising:
program instructions, stored on the one or more computer readable storage media, to report the unauthorized attempt by the second user to access the profile.

14. The computer program product of claim 8, further comprising:
program instructions, stored on the one or more computer readable storage media, to receive a notification that the machine is to be decommissioned; and
program instructions, stored on the one or more computer readable storage media, to record information about decommissioning of the machine.

15. A computer system for maintaining machine life cycle records, the computer system comprising:
one or more computer processors, one or more computer readable storage media, and program instructions stored on the computer readable storage media for execution by at least one of the one or more processors, the program instructions comprising:
program instructions to receive information about a machine;
program instructions to create a profile of the machine, wherein the profile includes the information about the machine;
program instructions to receive a request to access the profile from a first user;
program instructions to determine that the first user is authorized to access the profile; and
program instructions to permit the first user access to the profile of the machine.

16. The computer system of claim 15, further comprising:
program instructions, stored on the one or more computer readable storage media for execution by at least one of the one or more processors, to receive an indication that at least one aspect of the machine has been modified from an original design of the machine; and
program instructions, stored on the one or more computer readable storage media for execution by at least one of the one or more processors, to update the profile of the machine to include the at least one aspect of the machine that has been modified.

17. The computer system of claim 15, wherein the information about the machine includes factors selected from a group consisting of model number, serial number, manufacturing date, energy consumption, run cycle, errors, and modifications.

18. The computer system of claim 15, wherein program instructions to determine that the first user is authorized to access the profile comprise:
program instructions to access a list of users authorized to access the profile of the machine; and
program instructions to identify that the first user corresponds to a user from the list of users authorized to access the profile of the machine.

19. The computer system of claim 15, further comprising:
program instructions, stored on the one or more computer readable storage media for execution by at least one of the one or more processors, to receive a request to access the profile from a second user;
program instructions, stored on the one or more computer readable storage media for execution by at least one of the one or more processors, to determine that the second user is unauthorized to access the profile; and
program instructions, stored on the one or more computer readable storage media for execution by at least one of the one or more processors, to deny the second user access to the profile of the machine.

20. The computer system of claim 15, further comprising:
program instructions, stored on the one or more computer readable storage media for execution by at least one of the one or more processors, to receive a notification that the machine is to be decommissioned; and
program instructions, stored on the one or more computer readable storage media for execution by at least one of the one or more processors, to record information about decommissioning of the machine.
